(19) United States
(12) Patent Application Publication
(10) Pub. No.: US 2025/0392650 A1
(43) Pub. Date: Dec. 25, 2025

(54) APPARATUS, METHOD, AND COMPUTER PROGRAM

(71) Applicant: Nokia Technologies Oy, Espoo (FI)

(72) Inventors: Sankaran BALASUBRAMANIAM, Bangalore (IN); Shubhranshu SINGH, Munich (DE); Laurent THIÉBAUT, Massy (FR)

(21) Appl. No.: 18/878,405

(22) PCT Filed: Sep. 25, 2023
(86) PCT No.: PCT/EP2023/076389

§ 371 Date: Dec. 23, 2024

(30) Foreign Application Priority Data
Sep. 30, 2022 (IN) 202211056340

(51) Int. Cl. H04L 67/52; H04W 64/00

(52) U.S. Cl. CPC H04L 67/52; H04W 64/00

(57) ABSTRACT

There is provided an apparatus, method, and computer program for causing a user equipment to perform: receiving, when the user equipment is located in a first domain, from a first network function located in the first domain, assistance information identifying a user plane server providing location services for the user equipment over a user plane of another domain; and establishing, after handover of the user equipment from the first domain to the another domain is performed, a data connection with the user plane server for providing location services for the user equipment over the user plane of the another domain, based on the assistance information.

### FIELD OF THE DISCLOSURE

Various examples described herein generally relate to apparatus, methods, and computer programs, and more particularly (but not exclusively) to apparatus, methods and computer programs for apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to a first aspect, there is provided a method for a user equipment, the method comprising: receiving, when the user equipment is located in a first domain, from a first network function located in the first domain, assistance information identifying a user plane server providing location services for the user equipment over a user plane of another domain; and establishing, after handover of the user equipment from the first domain to the another domain is performed, a data connection with the user plane server for providing location services for the user equipment over the user plane of the another domain, based on the assistance information.

The data connection may be a packet data network, PDN, connection; and wherein said assistance information is utilized to reach the user plane server over the said PDN connection.

The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a second aspect, there is provided a method for a first network function located in a first domain, the method comprising: determining that a user equipment receiving location services over a user plane via the first domain is to be handed over from the first domain to another domain; and providing the user equipment with assistance information identifying a user plane server for providing, after the user equipment is handed over to the second domain, location services for the user equipment over a user plane of the another domain.

The determining that the user equipment is to be handed over is performed may be based on receiving a handover indication from a mobile management entity.

The providing may comprise directly providing the user equipment with the assistance information.

The providing may comprise indirectly providing the user equipment with assistance information via at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a third aspect, there is provided a method for a first network function located in a first domain, the method comprising: receiving a location request in respect of a user equipment located in a first domain; determining that the user equipment has previously received location services over a user plane via another domain; and providing the user equipment with assistance information identifying a user plane server for providing location services for the user equipment over a user plane.

The determining that the user equipment has previously received location services over a user plane via another domain may be performed based on receiving a handover indication from a mobile management entity.

The providing may comprise directly providing the user equipment with the assistance information.

The providing may comprise indirectly providing the user equipment with assistance information via at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a fourth aspect, there is provided a method for a second network function located in a first domain, the method comprising: receiving, from a first network function located in the first domain, assistance information identifying a user plane server for providing location services for a user equipment over a user plane of another domain; and providing the assistance information to the user equipment.

The second network function may be at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a fifth aspect, there is provided an apparatus for a user equipment, the apparatus comprising means for: receiving, when the user equipment is located in a first domain, from a first network function located in the first domain, assistance information identifying a user plane server providing location services for the user equipment over a user plane of another domain; and establishing, after handover of the user equipment from the first domain to the another domain is performed, a data connection with the user plane server for providing location services for the user equipment over the user plane of the another domain, based on the assistance information.

The data connection may be a packet data network, PDN, connection; and wherein said assistance information is utilized to reach the user plane server over the said PDN connection.

The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a sixth aspect, there is provided an apparatus for a first network function located in a first domain, the apparatus comprising means for: determining that a user equipment receiving location services over a user plane via the first domain is to be handed over from the first domain to another domain; and providing the user equipment with assistance information identifying a user plane server for providing, after the user equipment is handed over to the second domain, location services for the user equipment over a user plane of the another domain.

The determining that the user equipment is to be handed over is performed may be based on receiving a handover indication from a mobile management entity.

The means for providing may comprise means for directly providing the user equipment with the assistance information.

The means for providing may comprise means for indirectly providing the user equipment with assistance information via at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a seventh aspect, there is provided an apparatus for a first network function located in a first domain, the apparatus comprising means for: receiving a location request in respect of a user equipment located in a first domain; determining that the user equipment has previously received location services over a user plane via another domain; and providing the user equipment with assistance information identifying a user plane server for providing location services for the user equipment over a user plane.

The determining that the user equipment has previously received location services over a user plane via another domain may be performed based on receiving a handover indication from a mobile management entity.

The means for providing may comprise means for directly providing the user equipment with the assistance information.

The means for providing may comprise means for indirectly providing the user equipment with assistance information via at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to an eighth aspect, there is provided an apparatus for a second network function located in a first domain, the apparatus comprising means for:

receiving, from a first network function located in the first domain, assistance information identifying a user plane server for providing location services for a user equipment over a user plane of another domain; and providing the assistance information to the user equipment.

The second network function may be at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a ninth aspect, there is provided an apparatus for a user equipment, the apparatus comprising: at least one processor; and at least one memory comprising code that, when executed by the at least one processor, causes to apparatus to perform: receiving, when the user equipment is located in a first domain, from a first network function located in the first domain, assistance information identifying a user plane server providing location services for the user equipment over a user plane of another domain; and establishing, after handover of the user equipment from the first domain to the another domain is performed, a data connection with the user plane server for providing location services for the user equipment over the user plane of the another domain, based on the assistance information.

The data connection may be a packet data network, PDN, connection; and wherein said assistance information is utilized to reach the user plane server over the said PDN connection.

The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a tenth aspect, there is provided an apparatus for a first network function located in a first domain, the apparatus comprising: at least one processor; and at least one memory comprising code that, when executed by the at least one processor, causes to apparatus to perform: determining that a user equipment receiving location services over a user plane via the first domain is to be handed over from the first domain to another domain; and providing the user equipment with assistance information identifying a user plane server for providing, after the user equipment is handed over to the second domain, location services for the user equipment over a user plane of the another domain.

The determining that the user equipment is to be handed over is performed may be based on receiving a handover indication from a mobile management entity.

The providing may comprise directly providing the user equipment with the assistance information.

The providing may comprise indirectly providing the user equipment with assistance information via at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to an eleventh aspect, there is provided an apparatus for a first network function located in a first domain, the apparatus comprising: at least one processor; and at least one memory comprising code that, when executed by the at least one processor, causes to apparatus to perform: receiving a location request in respect of a user equipment located in a first domain; determining that the user equipment has previously received location services over a user plane via another domain; and providing the user equipment with assistance information identifying a user plane server for providing location services for the user equipment over a user plane.

The determining that the user equipment has previously received location services over a user plane via another domain may be performed based on receiving a handover indication from a mobile management entity.

The providing may comprise directly providing the user equipment with the assistance information.

The providing may comprise indirectly providing the user equipment with assistance information via at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a twelfth aspect, there is provided an apparatus for a second network function located in a first domain, the apparatus comprising: at least one processor; and at least one memory comprising code that, when executed by the at least one processor, causes to apparatus to perform: receiving, from a first network function located in the first domain, assistance information identifying a user plane server for providing location services for a user equipment over a user plane of another domain; and providing the assistance information to the user equipment.

The second network function may be at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a thirteenth aspect, there is provided an apparatus for a user equipment, the apparatus comprising: receiving circuitry for receiving, when the user equipment is located in a first domain, from a first network function located in the first domain, assistance information identifying a user plane server providing location services for the user equipment over a user plane of another domain; and establishing circuitry for establishing, after handover of the user equipment from the first domain to the another domain is performed, a data connection with the user plane server for providing location services for the user equipment over the user plane of the another domain, based on the assistance information.

The data connection may be a packet data network, PDN, connection; and wherein said assistance information is utilized to reach the user plane server over the said PDN connection.

The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a fourteenth aspect, there is provided an apparatus for a first network function located in a first domain, the apparatus comprising: determining circuitry for determining that a user equipment receiving location services over a user plane via the first domain is to be handed over from the first domain to another domain; and providing circuitry for providing the user equipment with assistance information identifying a user plane server for providing, after the user equipment is handed over to the second domain, location services for the user equipment over a user plane of the another domain.

The determining that the user equipment is to be handed over is performed may be based on receiving a handover indication from a mobile management entity.

The providing circuitry for providing may comprise providing circuitry for directly providing the user equipment with the assistance information.

The providing circuitry for providing may comprise providing circuitry for indirectly providing the user equipment with assistance information via at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a fifteenth aspect, there is provided an apparatus for a first network function located in a first domain, the apparatus comprising: receiving circuitry for receiving a location request in respect of a user equipment located in a first domain; determining circuitry for determining that the user equipment has previously received location services over a user plane via another domain; and providing circuitry for providing the user equipment with assistance information identifying a user plane server for providing location services for the user equipment over a user plane.

The determining that the user equipment has previously received location services over a user plane via another domain may be performed based on receiving a handover indication from a mobile management entity.

The providing circuitry for providing may comprise providing circuitry for directly providing the user equipment with the assistance information.

The providing circuitry for providing may comprise providing circuitry for indirectly providing the user equipment with assistance information via at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a sixteenth aspect, there is provided an apparatus for a second network function located in a first domain, the apparatus comprising: receiving circuitry for receiving, from a first network function located in the first domain, assistance information identifying a user plane server for providing location services for a user equipment over a user plane of another domain; and providing circuitry for providing the assistance information to the user equipment.

The second network function may be at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a seventeenth aspect, there is provided non-transitory computer readable medium comprising program instructions for causing an apparatus for a user equipment to perform: receiving, when the user equipment is located in a first domain, from a first network function located in the first domain, assistance information identifying a user plane server providing location services for the user equipment over a user plane of another domain; and establishing, after handover of the user equipment from the first domain to the another domain is performed, a data connection with the user plane server for providing location services for the user equipment over the user plane of the another domain, based on the assistance information.

The data connection may be a packet data network, PDN, connection; and wherein said assistance information is utilized to reach the user plane server over the said PDN connection.

The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to an eighteenth aspect, there is provided non-transitory computer readable medium comprising program instructions for causing an apparatus for a first network function located in a first domain to perform: determining that a user equipment receiving location services over a user plane via the first domain is to be handed over from the first domain to another domain; and providing the user equipment with assistance information identifying a user plane server for providing, after the user equipment is handed over to the second domain, location services for the user equipment over a user plane of the another domain.

The determining that the user equipment is to be handed over is performed may be based on receiving a handover indication from a mobile management entity.

The providing may comprise directly providing the user equipment with the assistance information.

The providing may comprise indirectly providing the user equipment with assistance information via at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a nineteenth aspect, there is provided non-transitory computer readable medium comprising program instructions for causing an apparatus for a first network function located in a first domain to perform: receiving a location request in respect of a user equipment located in a first domain; determining that the user equipment has previously received location services over a user plane via another domain; and providing the user equipment with assistance information identifying a user plane server for providing location services for the user equipment over a user plane.

The determining that the user equipment has previously received location services over a user plane via another domain may be performed based on receiving a handover indication from a mobile management entity.

The providing may comprise directly providing the user equipment with the assistance information.

The providing may comprise indirectly providing the user equipment with assistance information via at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a twentieth aspect, there is provided non-transitory computer readable medium comprising program instructions for causing an apparatus for a second network function located in a first domain to perform: receiving, from a first network function located in the first domain, assistance information identifying a user plane server for providing location services for a user equipment over a user plane of another domain; and providing the assistance information to the user equipment.

The second network function may be at least one of: a location management function; or a location services user plane function.

The first network function may be an access and mobility function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a twenty first aspect, there is provided a method for a user equipment, the method comprising: receiving assistance information from a first network function located in the first domain, based on a prior indication that a user plane-based location services session for the user equipment was active in another domain, wherein said assistance information identifies a user plane server for providing location services for the user equipment over a user plane of the first domain; and establishing, after handover of the user equipment from the another domain to the first domain is performed, a data connection with the user plane server for providing location services for the user equipment over the user plane of the first domain, based on the assistance information.

The data connection may be a packet data network, PDN, connection; and wherein said assistance information is utilized to reach the user plane server over the The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a twenty second aspect, there is provided an apparatus for a user equipment, the apparatus comprising means for: receiving assistance information from a first network function located in the first domain, based on a prior indication that a user plane-based location services session for the user equipment was active in another domain, wherein said assistance information identifies a user plane server for providing location services for the user equipment over a user plane of the first domain; and establishing, after handover of the user equipment from the another domain to the first domain is performed, a data connection with the user plane server for providing location services for the user equipment over the user plane of the first domain, based on the assistance information.

The data connection may be a packet data network, PDN, connection; and wherein said assistance information is utilized to reach the user plane server over the said PDN connection.

The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a twenty third aspect, there is provided an apparatus for a user equipment, the apparatus comprising: at least one processor; and at least one memory comprising code that, when executed by the at least one processor, causes to apparatus to perform: receiving assistance information from a first network function located in the first domain, based on a prior indication that a user plane-based location services session for the user equipment was active in another domain, wherein said assistance information identifies a user plane server for providing location services for the user equipment over a user plane of the first domain; and establishing, after handover of the user equipment from the another domain to the first domain is performed, a data connection with the user plane server for providing location services for the user equipment over the user plane of the first domain, based on the assistance information.

The data connection may be a packet data network, PDN, connection; and wherein said assistance information is utilized to reach the user plane server over the said PDN connection.

The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a twenty fourth aspect, there is provided an apparatus for a user equipment, the apparatus comprising: receiving circuitry to receiving assistance information from a first network function located in the first domain, based on a prior indication that a user plane-based location services session for the user equipment was active in another domain, wherein said assistance information identifies a user plane server for providing location services for the user equipment over a user plane of the first domain; and establishing circuitry for establishing, after handover of the user equipment from the another domain to the first domain is performed, a data connection with the user plane server for providing location services for the user equipment over the user plane of the first domain, based on the assistance information.

The data connection may be a packet data network, PDN, connection; and wherein said assistance information is utilized to reach the user plane server over the said PDN connection.

The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a twenty fifth aspect, there is provided non-transitory computer readable medium comprising program instructions for causing an apparatus for a user equipment to perform: receiving assistance information from a first network function located in the first domain, based on a prior indication that a user plane-based location services session for the user equipment was active in another domain, wherein said assistance information identifies a user plane server for providing location services for the user equipment over a user plane of the first domain; and establishing, after handover of the user equipment from the another domain to the first domain is performed, a data connection with the user plane server for providing location services for the user equipment over the user plane of the first domain, based on the assistance information.

The data connection may be a packet data network, PDN, connection; and wherein said assistance information is utilized to reach the user plane server over the The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

Said assistance information may comprise address information of the user plane server.

The assistance information may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

According to a twenty sixth aspect, there is provided a computer program product stored on a medium that may cause an apparatus to perform any method as described herein.

According to a twenty seventh aspect, there is provided an electronic device that may comprise apparatus as described herein.

According to a twenty ninth aspect, there is provided a chipset that may comprise an apparatus as described herein.

### BRIEF DESCRIPTION OF FIGURES

Some examples, will now be described, merely by way of illustration only, with reference to the accompanying drawings in which:

FIGS. 1A and 1B show a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of a network;

FIGS. 6A to 6B illustrate example signalling;

FIGS. 7A to 7B illustrate example signalling;

FIGS. 8 to 12 illustrate example operations that may be performed by apparatus described herein; and

FIGS. 13 and 14 illustrate example signalling.

### DETAILED DESCRIPTION

For brevity and clarity, the following describes such aspects with reference to a 5G wireless communication system and an Evolved Packet System (EPS). However, it is understood that such aspects are not limited to these wireless communication systems, and may, for example, be applied to other wireless communication systems (for example, current 6G proposals, IEEE 802.11, etc.).

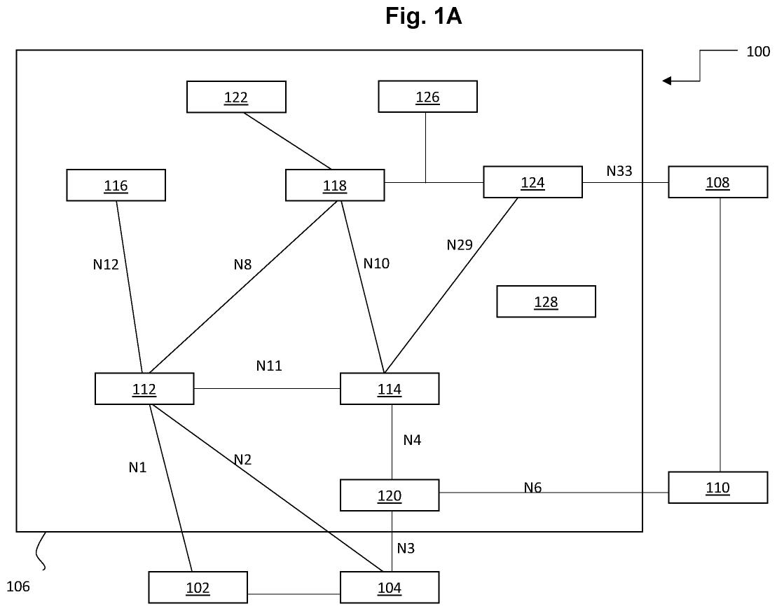

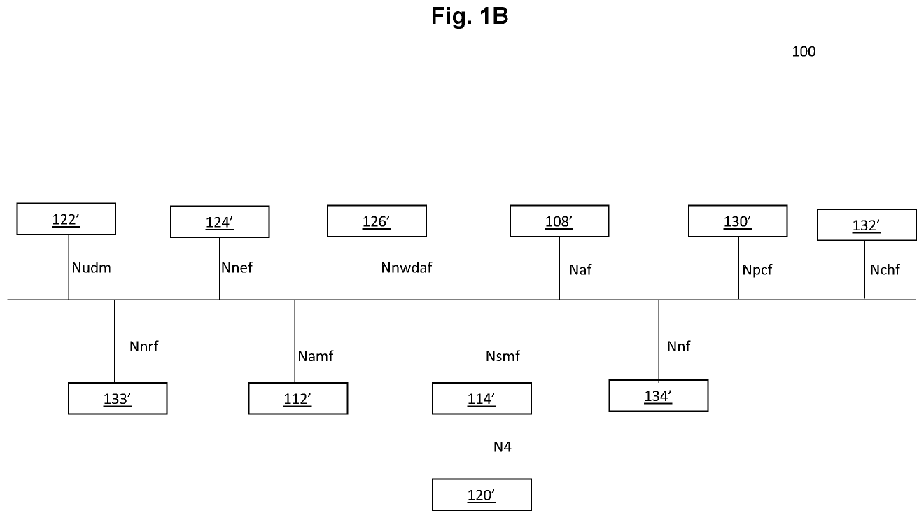

Before describing in detail the examples, certain general principles of a 5G wireless communication system are briefly explained with reference to FIGS. 1A and 1B.

FIG. 1A shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. The role of an NEF is to provide secure exposure of network services (e.g. voice, data connectivity, charging, subscriber data, and so forth) towards a 3rd party. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The network may further comprise a management data analytics service (MDAS) producer or MDAS Management Service (MnS) producer. The MDAS MnS producer may provide data analytics in the management plane considering parameters including, for example, load level and/or resource utilization. For example, the MDAS MnS producer for a network function (NF) may collect the NF's load-related performance data, e.g., resource usage status of the NF. The analysis of the collected data may provide forecast of resource usage information in a predefined future time window. This analysis may also recommend appropriate actions e.g., scaling of resources, admission control, load balancing of traffic, and so forth.

FIG. 1B shows a schematic representation of a 5GC represented in current 3GPP specifications. It is understood that this architecture is intended to illustrate potential components that may be comprised in a core network, and the presently described principles are not limited to core networks comprising only the described components.

FIG. 1B shows a 5GC 106′ comprising a UPF 120′ connected to an SMF 114′ over an N4 interface. The SMF 114′ is connected to each of a UDM 122′, an NEF 124′, an NWDAF 126′, an AF 108′, a Policy Control Function (PCF) 130′, an AMF 112′, and a Charging function 132′ over an interconnect medium that also connects these network functions to each other. The 5G core 106′ further comprises a network repository function (NRF) 133′ and a network function 134′ that connect to the interconnect medium.

3GPP has issued a number of releases (Rel) for defining operating communication protocols related to a communications network. Certain objectives and work are set in relation to Release 18 (Rel. 18).

Another example network is the Evolved Packet System (EPS). A UE communicates with an evolved packet core (EPC) via a base station (e.g., an eNB), which may signal a serving gateway (SGW) and a Mobility Management Entity (MME).

The MME is a key control-node for the LTE access-network. The MME is involved in the bearer activation/deactivation process and is also responsible for choosing the Serving Gateway for a UE at the initial attach and at time of intra-LTE handover involving Core Network (CN) node relocation.

The SGW routes and forwards user data packets, while also acting as the mobility anchor for the user plane during inter-eNB handovers and as the anchor for mobility between LTE and other 3GPP technologies.

3GPP is working on use cases, technical requirements and corresponding enhancements as part of ongoing Rel-18 enhancements. At least one of these key issues relates to how to support location service continuity given a UE's mobility.

3GPP defines the handling of ongoing services/sessions during mobility for certain use cases (such as, for example, voice call or data session). In particular, the handling of a LoCation Services (LCS) during mobility procedures is defined in 3GPP standards in relation to control plane procedures. Certain proposals have considered providing a LCS session over the user plane for providing location services. However, there has been no work performed on how such a user plane LCS session would be affected as a result of the UE being handed from a first network domain to a second network domain. It is therefore unclear on whether an ongoing LCS session over the user plane should be terminated or to be maintained after a mobility-based event. Further, it is not defined whether, if the LCS session is continued, how such a continuity would work.

There are a plurality of resulting impacts associated with this.

For example, LCS sessions may be terminated in response to a mobility event. In this case, the LCS Client has to re-initiate the session after the procedure. This introduces additional network signalling, which may be considered an inefficient use of overhead resources for certain use cases.

Further, a location management function (LMF) may be unaware of the mobility-based event at all. This can lead to inaccurate positioning estimates being obtained in respect of the mobile UE.

Further, as there are no clear specifications, inter-vendor tests could fail when network functions from different vendors make different assumptions regarding whether another network function supports continuity of an LCS session. For example, an AMF from vendor-1 may operate with the expectation that continuity should work, whereas LMF from vendor-2 may not support continuity.

Further, LCS sessions could be enabled as part of other critical services (such as, for example, emergency calls). Those critical services may be impacted due to the lack of certainty, leading to regulatory issues.

The present application has identified that at least one of the above-mentioned issues may be mitigated by providing mechanisms for handling LCS sessions over a user plane with respect to different mobility procedures. In particular, the present application has identified that it can be useful to specify how an LCS session continuity can be provided in the event of a mobility-based event.

The following provides example signalling that may be performed by entities described herein. By way of illustrative example, these are discussed in the context of an evolved packet system (EPS) and a 5G System (5GS).

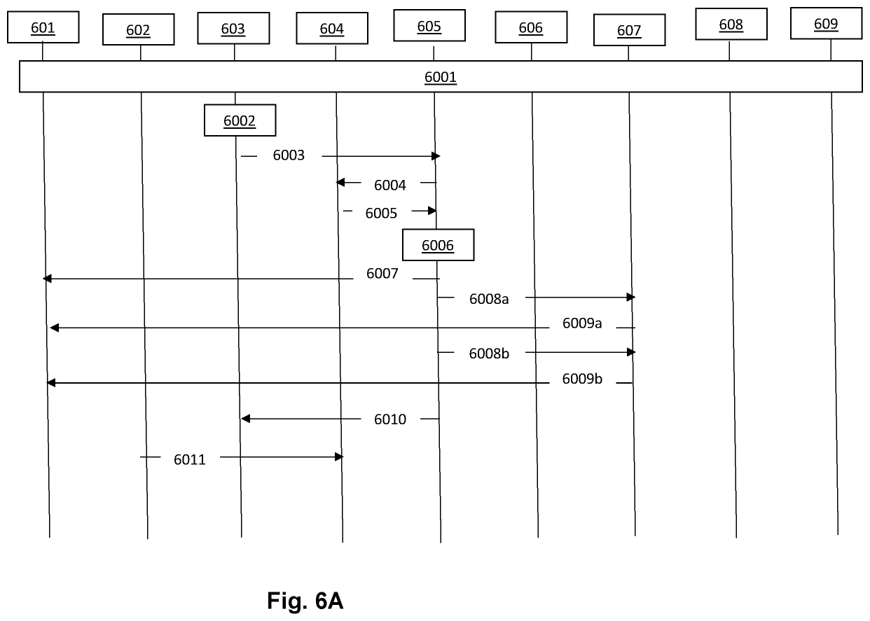

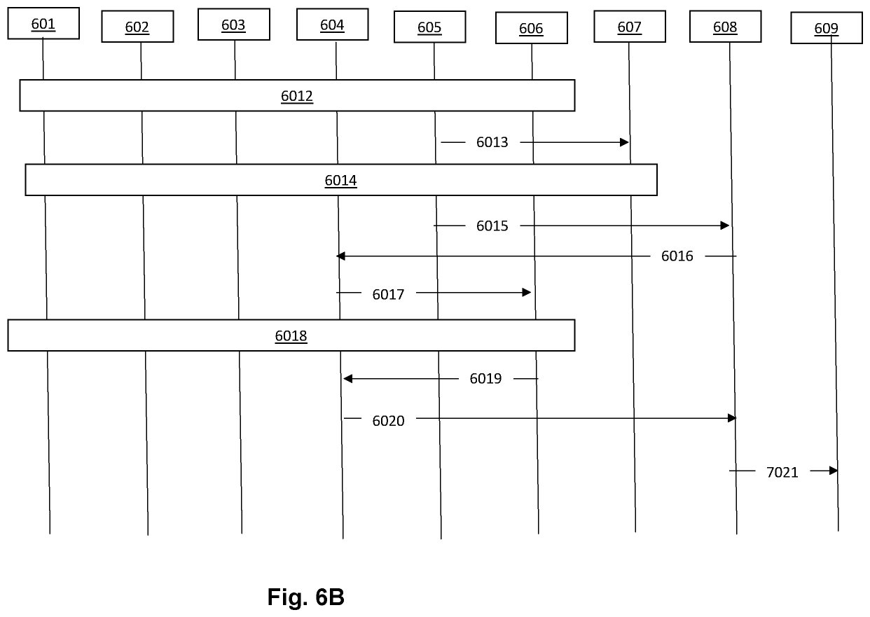

FIGS. 6A and 6B illustrate example signalling that may be performed when a UE moves from a 5GS to an Evolved Packet System. The operations of FIG. 6B may be performed subsequent to the operations of FIG. 6A.

FIGS. 6A and 6B illustrate signalling that may be performed between a UE 601, an Evolved Universal Mobile Telecommunications System (UMTS) Terrestrial Radio Access Network (E-UTRAN) 602, a Next Generation Radio Access Network (NG_RAN) 603, an MME 604, an AMF 605, an Evolved Serving Mobile Location Centre (E_SML C) 606 (which is a location function located in an EPS), a Location Management Function_location service user plane (LMF_LCUP) 607, a Gateway Mobile Location Centre (GMLC) 608, and an LCS client 609.

The LMF_LCUP refers to an LCS service function that is implemented by an LMF, although it is understand that the present description is not limited to this. The term “LCUP” used herein may refer to a network element or a network function for location service on the user plane, which may e.g. correspond to user plane part of the LMF or to an Secure User Plane Location (SUPL) platform defined in Open Mobile Alliance (OMA) specifications. The LCUP function may handle location operations on the user plane and can be used with the associated LMF, for example to enhance location service on the control plane. The LMF and the associated LCUP can be located within the same region, for example, co-located with each other or may communicate via an interface or implementation specific behaviour. Additional or alternatively, the LMF and the associated LCUP can also support similar positioning methods so that they can match each other.

The Gateway Mobile Location Centre (GMLC) comprises functionality required to support location-based services (LBSs). The GMLC is the first node an external LBS client accesses in a Global System for Mobile Communications (GSM), UMTS or LTE network. The GMLC may request routing information from the home location register (HLR) or home subscriber server HSS). After performing registration authorization, it sends positioning requests to either the visited mobile switching centre (VMSC), SGSN serving GPRS support node (SGSN) or mobile switching centre (MSC) server and receives final location estimates from the corresponding entity.

During 6001, an LCS session is set up for the UE 601 over the 5G user plane.

During 6002, the NG_RAN 603 determines that a handover is to be performed for handing the UE 601 over to the EPS from the 5GS. This determination may be performed based on any of a plurality of factors. For example, this determination may be made based on (e.g., in response to) a determination that the UE 601 may obtain a better quality of service and/or quality of experience with the other network.

During 6003, based on the determination of 6002, the NG_RAN 603 signals the AMF 605. This signalling of 6003 may request that the UE 601 be handed over from the 5GS to the EPS.

During 6004, based on the signalling of 6003, the AMF 605 signals a relocation request in respect of the UE 601 to the MME 604. The relocation request indicates that the UE 601 is to be handed over from the 5GS to an EPS.

During 6005, the MME 604 responds to the signalling of 6004. The signalling of 6005 may comprise a relocation response.

During 6006, the AMF 605 determines that a user plane LCS session is active in respect of the UE 601. The AMF 605 may determine that a given UE has an LCS session active when the AMF 605 has previously requested that an LMF provides a location for this UE 601. This location request may provide the AMF with an LCS correlation identifier. Further, the AMF 605 may determine that a given UE has an LCS session active when an LMF signals information to the AMF 605 (which may be to forward to a radio access network and/or the UE) that comprises the same LCS correlation identifier that the AMF 601 had sent earlier. This may allow the AMF 605 to remain aware of a whether or not a user plane LCS session is active in respect of the UE 601.

Based on this determination, the AMF 605 may determine to provide the UE 601 with information relating to the UE's LCS user plane assistance (such as, for example, an Internet Protocol (IP address or FQDN).). Examples of the assistance information is provided further below. This assistance information may be signalled to the UE in any of a plurality of different ways.

For example, the AMF 605 may provide the UE 601 with the assistance information by signalling the assistance information directly to the UE 601 using non-access stratum (NAS) signalling procedures. This is represented as 6007 in FIG. 6A. The example signalling of 6007 may be effected by signalling LCUP assistance data to the UE 601.

The LCUP assistance information can be received in many different ways. In some examples, this assistance data may be signalled using NAS: DL-NAS-Transport service operation.

As another example, the AMF 605 may signal the assistance information to the UE 601 indirectly via the LMF_LCUP 607. This is illustrated with respect to 6008a-6009a, and with respect to 6008b-6009b, which are both described further below.

6008a-6009a illustrate example information in which the AMF 605 provides the assistance information to the UE 601 indirectly via the LMF_LCUP 607, with the LMF_LCUP 607 signalling the assistance information to the UE using LPP.

During 6008a, the AMF 605 signals the LMF_LCUP 607. The LMF_LCUP 607 may signal the assistance information to the UE 601 based on this signal from AMF 605 in 6008a. This signal may, for example, trigger the LMF_LCUP 607 to signal the assistance information to the UE 601. This signalling of 6008a may comprise an Nlmf_Location_Prepare_Transfer service operation.

During 6009a, the LMF_LCUP 607 signals the UE 601. This signalling may comprise the LCUP assistance data mentioned above. This signalling may be effected using an LPP service operation.

6008b-6009b illustrate example information in which the AMF 605 provides the assistance information to the UE 601 indirectly via the LMF_LCUP 607, with the LMF_LCUP 607 signalling the assistance information to the UE using SUPL.

During 6008b, the AMF 605 signals the LMF_LCUP 607. The LMF_LCUP 607 may signal the assistance information to the UE 601 based on this signal from AMF 605 in 6008b. This signal may, for example, trigger the LMF_LCUP 607 to signal the assistance information to the UE 601. This signalling of 6008b may comprise an Nlmf_Location_Prepare_Transfer service operation.

During 6009b, the LMF_LCUP 607 signals the UE 601. This signalling may comprise a SUPL-INIT service operation.

With the assistance information having been provided to the UE via at least one of 6007 to 6009b, during 6010, the AMF 605 signals a handover command to the NG_RAN 603 in respect of the UE 601. The handover command may indicate that the UE 601 is to be handed over from the 5GS to the EPS. The handover command may be signalled using a HO_Command signalling

During 6011, the E-UTRAN network 602 signals an indication to the MME 604 that the UE 601 has been handed over to the E-UTRAN network. This may be signalled using a HO_Notify service operation.

During 6012, after handover of the UE 601 to the EPS has been completed, the UE 601 uses the PDN connection that corresponds to the PDU session that it was using over 5GS to interface with the user plane location server to contact the user plane location server whose address was provided to the UE during 6007, 6009a, and/or 6009b.

6013 to 6014 relate to the AMF 605 cancelling the previously configured LCS session in the 5GS.

During 6013, the AMF 605 signals the LMF_LCUP 607. This signalling of 6013 indicates that the location services session is to be cancelled in the 5GS. This signalling may be effected using, for example, an Nlmf_Location_CancelLocation_Request service mechanism.

During 6014, the user plane LCS session is cancelled.

During 6015, the AMF 605 signals the GMLC 608. This signalling of 6015 may provide the GMLC 608 with an indication that the UE 601 has been handed over from the 5GS to an EPS. This signalling of 6015 may additionally provide the GMLC 608 with an identifier for the UE 601, an indication that there has been an LCS Session failure, and/or an identifier of the MME 604. The signalling of 6015 may be effected using, for example, an Namf_Location_ProvidePositioningInfo Resp service operation.

6016 and 6017 relate to entities on the EPS being requested to provide a location element for the UE 601.

During 6016, the GMLC 608 signals the MME 604. This signalling of 6016 may request that the MME 604 provides the GMLC 608 with a location estimate for the location of the UE 601. This signalling may comprise an identifier of the UE 601 (such as the identifier provided during 6015). This signalling may comprise an indication of a Quality of Service (QOS) associated with the LCS being requested. The indication of a Quality of Service (QOS) and the UE identity sent to the MME may correspond to EPS translation of the parameters that were sent to the AMF.

During 6017, the MME 604 signals the E_SML C 606. This signalling may comprise a request for a location of the UE 601. This signalling of 6017 may comprise the identifier of the UE 601 provided during 6016. This signalling of 6017 may comprise the QoS comprised in the signalling of 6016.

During 6018, an LCS session is established over the EPC user plane. In particular, given the PDN connection to the user plane server, the E-SMLC 606 selects to conduct the LCS session using user plane data. OMA-SUPL (not shown) may also be involved during 6018 on the EPS side. It is assumed that the process of 6018 provides the E_SML C 606 with a location estimate for the UE 601.

During 6019, the E-SMLC 606 signals the MME 604. This signalling provides a location estimate for the UE 601 to the MME 604. This signalling may comprise the identifier of the UE 601 provided during 6017.

During 6020, the MME 604 signals the GML-C 608. This signalling of 6020 may comprise the location estimate of 6019. This signalling of 6020 may comprise an identifier for the UE 601.

During 6021, the GML-C 608 signals the LCS client 609. This signalling of 6021 may comprise the location estimate of 6020. This signalling of 6021 may comprise an identifier for the UE 601.

The location estimation discussed above may be as specified in EPS specifications. For instance, providing the UE with the information of 6007 to 6009b (inclusive) may not affect how a subsequent location is provided via EPS. Further, the LCS client is unaware of any UE mobility handling, and LCS session continuity is maintained.

However, the SUPL may be indicated as being used on both the EPS and 5GS sides for enabling reuse of a user plane session, which simplifies the signalling in the UE and in the 5G core.

The assistance information described above may comprise: an identifier and/or an address for a user plane server for the UE (e.g., an IP address and/or a Fully Qualified Domain Name (FQDN) of the user plane server/LCUP/LMF_LCUP); and/or assistance data for assisting setup of a secure (e.g. TLS) connection between the UE and the (location) user plane server; and/or assistance data for assisting signalling between the UE and the (location) user plane server. For example, the assistance information provides the UE with information to be used when the UE is in an EPS while the UE is in a 5GS.

The LCUP instance assistance information may alternatively or additionally comprise security information for establishing a user plane (UP) session between the terminal device and the LCUP function instance (e.g., the LMF_LCUP). The security information can include security material that UE could use to setup the User Plane session between the UE and the LCUP. In some examples, the security information may comprise transport layer security (e.g. TLS) attribute information for establishing the secured user plane connection. The TLS attribute information may e.g., correspond to a key to be used as a pre-shared key to secure the TLS link between the UE and the LCUP. It may be used to establish SSL/TLS connection between UE and LCUP. In some examples, the security information may further comprise a hash-based message authentication code field for example when UE wants to start the session by SUPL Position Initialization (POS INIT) message to initiate the positioning protocol session.

In some examples, the LCUP instance assistance information may alternatively or additionally comprise correlation information on an ongoing control plane location procedure. The correlation information contains information used to correlate an ongoing control plane location procedure with the user plane connection to further ensure the security of the user plane connection. A network element such as a LMF could allocate a correlation identifier as correlation information to a positioning request, which may contain for example, a LMF address and a positioning request identifier.

The LMF could provide the correlation identifier to the terminal device as part of the LCUP assistance information over a control plane, for example via the LTE Positioning Protocol (LPP) signaling. In later operation of establishing user plane connection between the terminal device and the LUCP, the correlation identifier can be used to correlate an ongoing control plane location procedure with the user plane connection, which will be described hereinafter.

The LCUP assistance information may further comprise information on a port at the LCUP function instance, for example a Transmission Control Protocol (TCP) or Uniform Datagram Protocol (UDP) port at the LCUP. Additionally or alternatively, the LCUP assistance information may also comprise information on positioning methods or protocols supported by the LCUP function instance.

The UE may store the received assistance information and, after the user equipment is handed over to EPS, initiate a PDN Connection or use a PDU session handed over to EPS as a PDN connection in order to contact the (location) user plane server whose contact information it has received in the assistance data address/identifier. The UE may initiate a domain name service (DNS) query to a DNS server for obtaining an address for the user plane server when the FQDN is provided in assistance data. The UE autonomously establishes this connection to the user plane server (e.g., without receiving a trigger from the LTE/EPS network) once on LTE. This can ensure that there are no impacts to the LTE network in certain use cases.

The UE may further perform signalling to establish a TLS connection on top of the user plane connection. The UE may further perform signalling in SUPL to ensure that the SUPL connection is ready for eSMLC to establish the LCS session on top of the SUPL, TLS and IP protocol layers.

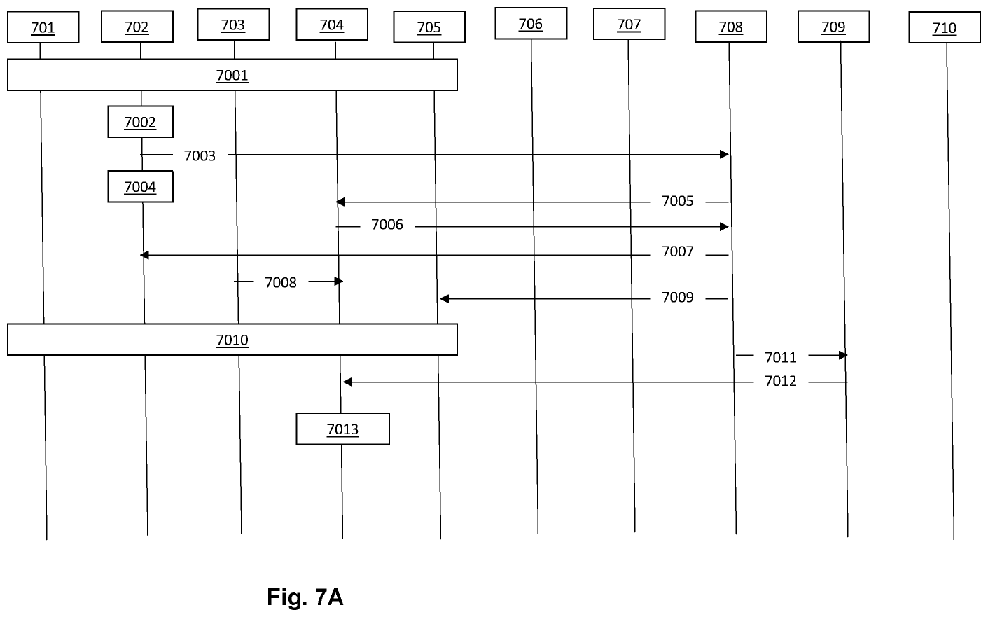

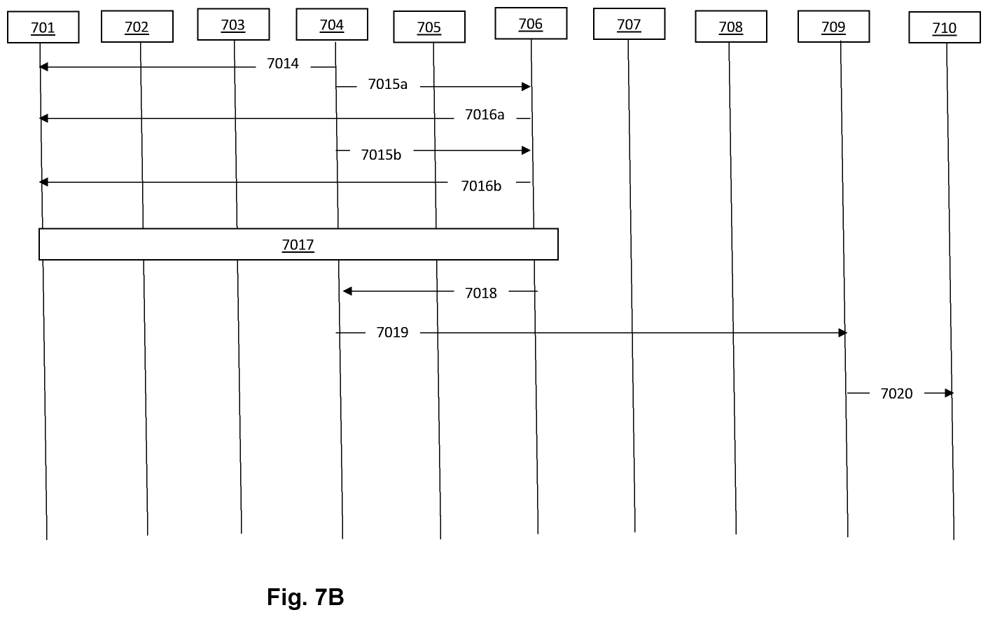

FIGS. 7A and 7B illustrate how the presently described techniques may be applied in the case of a user equipment being moved from an EPS to a 5GS. The operations of FIG. 7B may be performed subsequent to the operations of FIG. 7A.

FIGS. 7A and 7B illustrate signalling that may be performed by a UE 701, an E-UTRAN 702, an NG-RAN 703, an AMF 704, an E_SML C 705, an LMF_LCUP 706, an NRF 707, an MNE 708, a GMLC 709, and an LCS client 710.

During 7001, an LCS session is established over a user plane of the EPS.

During 7002, the E-UTRAN 702 determines that the UE is to be handed over from the EPS to a 5GS.

During 7003, based on the determination of 7002, the E-UTRAN 703 signals the MME 708. This signalling of 7003 indicates that a handover is requested for handing over the UE from the EPS to the 5GS.

During 7004, the E-UTRAN 702 detects an LCS user plane session that is currently established in respect of the UE 701. This LCS user plane session be detected by the E-UTRAN 702 monitoring use of an LCS correlation identifier associated to the UE 701 being signalled through the E-UTRAN 702.

During 7005, the MME 708 signals the AMF 704. This signalling of 7005 comprises an indication that the UE 701 will be handed over to the 5GS from the EPS. This signalling of 7005 comprises an indication that there was an existing user plane-based LCS session active in the EPS in respect of UE 701. As mentioned above, the AMF 605 may be aware that there is an active LCS session is on for a given UE on 5GS from receipt of a location services correlation identifier. The MME 708 in the present case may be similarly aware that there is an active LCS session for the UE 701 by receiving and/or transmitting signalling comprising an analogous correlation identifier. Therefore, the MME 708 may be aware of the LCS session status without designated signalling to the MME 708 for this purpose. For instance, the LCS user plane session be detected by the MME 708 monitoring use of an LCS correlation identifier associated to the UE 701 being signalled through the MME 708. During 7006, the MME 708 responds to the signalling of 7005.

During 7007, the MME 708 signals the E-UTRAN 702. This signalling may comprise a handover command for causing the E-UTRAN to handover the UE 701 to the NG_RAN 702.

During 7008, the NG_RAN 703 signals the AMF 704. This signalling may notify the AMF that a handover of the UE 701 to the NG-RAN has been performed.

7009 to 7012 relate to the LCS session being cancelled in the EPS network.

During 7009, the MME 708 signals the E_SML C 705. This signalling of 7009 comprises an instruction to cancel the LCS session in the EPS network.

During 7010, the user plane LCS session is cancelled in the EPS network.

During 7011, the MME 708 signals the GMLC 709. This signalling of 7011 may comprise a location response. The signalling of 7011 may comprise an identifier of the UE 701. The signalling of 7011 may comprise a failure indication. The signalling of 7011 may comprise an indication that handover has been performed to the 5GS. The signalling of 7011 may comprise an address for the AMF 704 (or some other identifier that may be used to obtain an address for the address for the AMF 704).

During 7012, the GMLC 709 signals the AMF 704 identifier in the signalling of 7011. This signalling of 0712 may request for the location of the UE 701. This signalling of 7012 may comprise the identifier for the UE 701 provided during 7011. The signalling of 7012 may comprise an indication of a Quality of Service for the LCS session.

During 7013, the AMF 704 determines whether the AMF 704 had previously received information about the LCS session over the user plane. For example, the AMF 704 determines whether the AMF 704 previously received the signalling of 7005 from the MME 708.

Based on the AMF 704 determining that the AMF has previously received said LCS session information, the AMF 704 provides the UE 701 with an address for the LCS user plane server. This provision may be effected via 7014, and/or via 7015a and 7016a, and/or via 7015b and 7016b. These are described further below.

During 7014, the AMF 704 signals the UE 701. This signalling of 7014 may comprise LCUP assistance data. The LCUP assistance data may be as described above in relation to FIGS. 6A and 6B.

During 7015a, the AMF 704 signals the LMF_LCUP 706. This signalling of 7015a may comprise a request for the LMF_LCUP to provide the LCUP assistance data to the UE 701. This signalling of 7015a may comprise an identifier for the UE 701.

This signalling of 7015a may comprise an LCS correlation identifier associated to the UE 701. This signalling of 7015a may comprise an indication of the QoS for the LCS session that was received during 7012. This signalling of 7015a may comprise an indication that the UE 701 has an associated user plane LCS session.

During 7016a, the LMF_LCUP 706 signals the UE 701. This signalling of 7016a provides the UE 701 with the LCUP assistance data. This signalling of 7016a may be provided using LPP.

During 7015b, the AMF 704 signals the LMF_LCUP 706. This signalling of 7015b may comprise a request for the LMF_LCUP to provide the LCUP assistance data to the UE 701. This signalling of 7015b may comprise an identifier for the UE 701. This signalling of 7015b may comprise an LCS correlation identifier associated to the UE 701. This signalling of 7015b may comprise an indication of the QoS for the LCS session that was received during 7012. This signalling of 7015b may comprise an indication that the UE 701 has an associated user plane LCS session.

During 7016b, the LMF_LCUP 706 signals the UE 701. This signalling of 7016b provides the UE 701 with the LCUP assistance data. This signalling of 7016b may be provided using OMA-SUPL.

During 7017, a user plane LCS session is established over the 5GS.

During 7018, the LMF_LCUP 706 signals the AMF 704. This signalling of 7018 may comprise a location estimate for the UE 701. This signalling of 7018 may comprise an identifier for the UE 701. This signalling of 7018 may comprise the LCS correlation identifier of 7016a or 7016b. This signalling of 7018 may comprise an Nlmf_Location_DetermineLocationResponse service operation. This signalling of 7018 may be signalled based on the signalling of 7015.

During 7019, the AMF 704 signals the GLMC 709. This signalling may comprise the location estimate provided in 7018. This signalling may comprise the identifier of the UE 701 provided in the signalling of 7018. The signalling of 7019 may comprise an Namf_Location_ProvidePositionInfo response service operation.

During 7020, the GMLC 709 signals the LCS client 710. This signalling of 7020 may comprise the location estimate provided in 7019. This signalling may comprise the identifier of the UE 701 provided in the signalling of 7019.

In this example of FIGS. 7A and 7B, the LMF may choose to have the LCS session over user plane based on the receipt of an indication from the AMF. The LMF may alternatively or additionally choose to have the LCS session over user plane based on an internal configuration of the LMF.

In both of the above-mentioned examples of FIGS. 6A to 6B and 7A to 7B, the user plane connection from the UE is handled just like the other Packet Data Unit (PDU) sessions for assisting in keeping the LCS over the user plane session is kept active during mobility.

However, the SUPL is indicated as being used both on EPS and 5GS sides for enabling reuse simplifying the signalling in the UE and in the 5G core.

The assistance information described above may comprise: an identifier and/or an address for a user plane server of the UE (e.g., an IP address and/or a Fully Qualified Domain Name (FQDN) of the user plane server); and/or assistance data for assisting setup of a secured (e.g. TLS) connection between the UE and the user plane (location) server; and/or assistance data for assisting signalling between the UE and the (location) user plane server. In some examples, the assistance information provides the UE with information to be used when the UE is in 5GS.

The assistance information described above may comprise at least one of: an identifier and/or an address for a user plane server of the UE (e.g., an IP address and/or a Fully Qualified Domain Name (FQDN) of the user plane server); and/or assistance data for assisting setup of a secured (e.g. TLS) connection between the UE and the (location) user plane server; and/or assistance data for assisting signalling between the UE and the (location) user plane server. In some examples, the assistance information provides the UE with information to be used when the UE is in an EPS while the UE is in a 5GS.

The LCUP instance assistance information may alternatively or additionally include security information for establishing a user plane (UP) session between the terminal device and the LCUP function instance. The security information can include security material that UE could use to setup the User Plane session between the UE and the LCUP. In some examples, the security information may comprise transport layer security (TLS) attribute information for establishing the secured user plane connection. The TLS attribute information may e.g., correspond to a key to be used as a pre-shared key to secure the TLS link between the UE and the LCUP. It may be used to establish SSL/TLS connection between UE and LCUP. In some examples, the security information may further comprise a hash-based message authentication code field for example when UE wants to start the session by SUPL Position Initialization (POS INIT) message to initiate the positioning protocol session.

In some examples, the LCUP instance assistance information may alternatively or additionally comprise correlation information on an ongoing control plane location procedure. The correlation information contains information used to correlate an ongoing control plane location procedure with the user plane connection to further ensure the security of the user plane connection. A network element such as a LMF could allocate a correlation identifier as correlation information to a positioning request, which may contain for example, a LMF address and a positioning request identifier.

The LMF could provide the correlation identifier to the terminal device as part of the LCUP assistance information over a control plane, for example via the LTE Positioning Protocol (LPP) signaling. In later operation of establishing user plane connection between the terminal device and the LUCP, the correlation identifier can be used to correlate an ongoing control plane location procedure with the user plane connection, which will be described hereinafter.

The LCUP assistance information may further comprise information on a port at the LCUP function instance, for example a Transmission Control Protocol (TCP) or Uniform Datagram Protocol (UDP) port at the LCUP. Additionally or alternatively, the LCUP assistance information may also comprise information on positioning methods or protocols supported by the LCUP function instance.

The UE may store the received assistance information and initiate a PDN Connection to the receiver user plane address/identifier after the user equipment is handed over to EPS. The UE may initiate a domain name service (DNS) query to a DNS server for obtained an address for the user plane server when the FQDN is provided. The UE autonomously establishes this connection to the user plane server (e.g., without receiving a trigger from the LTE/EPS network) once on LTE. This will ensure that there are no impacts to the LTE network.

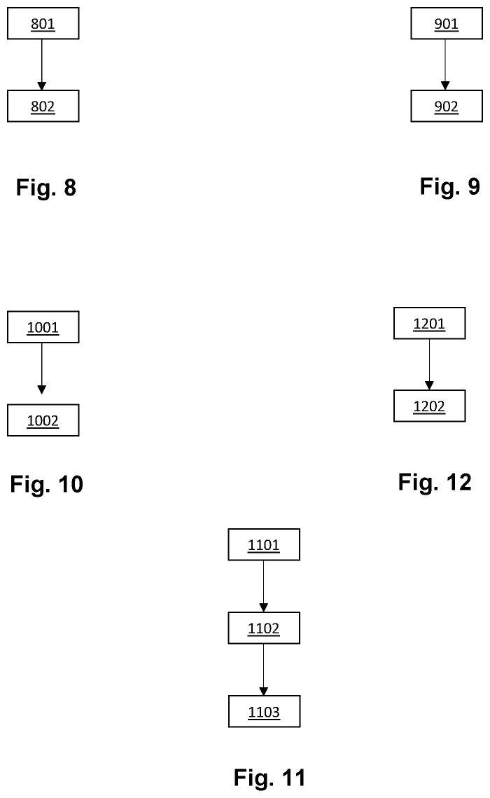

FIGS. 8 to 12 illustrates aspects of the above examples of FIGS. 6A to 7B. FIG. 8 relates to operations that may be performed by a user equipment.

During 801, the user equipment receives, when the user equipment is located in a first domain, from a first network function located in the first domain, assistance information identifying a user plane server providing location services for the user equipment over a user plane of another domain.

During 802, the user equipment establishes, after handover of the user equipment from the first domain to the another domain is performed, a data connection with the user plane server for providing location services for the user equipment over the user plane of the another domain, based on the assistance information.

These operations may be performed when a user equipment is being handed over from the first domain to the another domain.

The data connection may be a packet data network, PDN, connection; and wherein said assistance information is utilized to reach the user plane server over the said PDN connection.

The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

After establishing a data connection, the user equipment may use the data connection for transmitting data. The data connection may be used for providing location services to the user equipment over the user plane of the another domain.

FIG. 9 illustrates operations that may be performed by an apparatus for a user equipment.

During 901, the user equipment receives assistance information from a first network function located in the first domain, based on a prior indication that a user plane-based location services session for the user equipment was active in another domain, wherein said assistance information identifies a user plane server for providing location services for the user equipment over a user plane of the first domain. The indication may have previously been transmitted from an MME to an AMF.

During 902, the user equipment establishes, after handover of the user equipment from the another domain to the first domain is performed, a data connection with the user plane server for providing location services for the user equipment over the user plane of the first domain, based on the assistance information.

These operations of FIG. 9 may be performed when a user equipment is being handed over from the another domain to the first domain.

The data connection may be a packet data network, PDN, connection; and wherein said assistance information is utilized to reach the user plane server over the said PDN connection.

The assistance information may be received prior to a command for said handover being sent towards the user equipment.

The first domain may be configured as a third generation partnership project, 3GPP, 5G system, 5GS; and wherein the another domain may be configured as a 3GPP evolved packet system, EPS.

The assistance information may be received from the access and mobility function over non-access stratum, NAS, signalling.

The assistance information may be received within a downlink-NAS-transport message from the access and mobility function.

The assistance information may be received from the location management function over long-term evolution positioning protocol, LPP, signalling.

The assistance information may be received within location services user plane, LCUP, assistance information data from the location management function.

The assistance information may be received from the location management function over secure user plane location, SUPL, signalling.

The assistance information may be received within a SUPL initiation message from the location management function.

The first network function may be an access and mobility function.

The first network function may be a location management function.

The first network function may be a location services user plane function.

After establishing a data connection, the user equipment may use the data connection for transmitting data. The data connection may be used for providing location services to the user equipment over the user plane of the first domain.

FIG. 10 illustrates operations that may be performed by a first network function located in a first domain. The first network function may correspond to the first network function described above in relation to FIG. 8 and/or FIG. 9.

During 1001, the first network function determines that a user equipment receiving location services over a user plane via the first domain is to be handed over from the first domain to another domain.

During 1002, the first network function provides the user equipment with assistance information identifying a user plane server for providing, after the user equipment is handed over to the second domain, location services for the user equipment over a user plane of the another domain.

The determining that the user equipment is to be handed over is performed based on receiving a handover indication from a mobile management entity.

FIG. 11 illustrates operations that may be performed by a first network function located in a first domain. The first network function may correspond to the first network function described above in relation to FIG. 8 and/or FIG. 9.

The providing may comprise directly providing the user equipment with the assistance information.

The providing may comprise indirectly providing the user equipment with assistance information via at least one of: a location management function; or a location services user plane function.

During 1101, the first network function receives a location request in respect of a user equipment located in a first domain.

During 1102, the first network function determines that the user equipment has previously received location services over a user plane via another domain.

During 1103, the first network function provides the user equipment with assistance information identifying a user plane server for providing location services for the user equipment over a user plane. In case of the UE being handed over for the first domain to the second domain, this user plane may be a user plane of the another domain. In the case of the user equipment being handed over from the another domain to the first domain, the user plane may be in the first domain

The determining that the user equipment has previously received location services over a user plane via another domain may be performed based on receiving a handover indication from a mobile management entity

The providing may comprise directly providing the user equipment with the assistance information.

The providing may comprise indirectly providing the user equipment with assistance information via at least one of: a location management function; or a location services user plane function.

FIG. 12 illustrates operations that may be performed by a second network function located in a first domain. The second network function may interact with at least one of the apparatus of FIGS. 10 and 11 in order to forward assistance information to a user equipment. The user equipment may be the user equipment of FIG. 8, or FIG. 9, or some other user equipment.

During 1201, the second network function receives, from a first network function located in the first domain, assistance information identifying a user plane server for providing location services for a user equipment over a user plane of another domain.

During 1202, the second network function provides the assistance information to the user equipment.

The second network function may be at least one of: a location management function; or a location services user plane function.

The first network function in the examples of FIGS. 10 to 12 may be an access and mobility function.

Said assistance information function in the examples of FIGS. 8 to 12 may comprise address information of the user plane server.

The assistance information function in the examples of FIGS. 8 to 12 may comprise at least one of the following: an address of the user plane server; a unique identifier of the user plane server; a location services correlation identifier; one or more fully-qualified domain name (FQDN) of the user plane server; Secure User Plane Location assistance information for establishing a user plane connection in the second domain; or transport layer security assistance information for establishing a user plane connection in the second domain.

In the above examples of FIGS. 8 to 12, the first domain may be a 5GS and the another domain may be an EPS. Alternatively, the first domain may be an EPS and the second domain may be a 5GS.

The above-mentioned examples illustrate that, the for the specific case of moving between a 5GS and an EPS, the mechanisms may be asymmetric with respect to the direction in which the user equipment is moved.

For example, in the 5GS to EPS mobility case, EPS-related assistance information may be provided in the 5GS, and the UE being handed over to the EPS may use this information after moving to the EPS.

When the UE is moved over in the opposite direction (i.e., the UE is handed over from the EPS to the 5GS), the UE is not provided assistance information while the UE is located in the EPS. This may help to minimize impacts to the EPS. However, there is provided an optional indication from an MME to an AMF that may indicate the presence of such an LCS/UP session in EPS that was used by the UE while the UE was located in the EPS for location services. The AMF may choose to use that (or) based on LMF configuration in order to start an LCS/user plane session in the 5GS.

A potential change request illustrating how the above-mentioned examples may be reflected in current specifications is provided as Annex A.

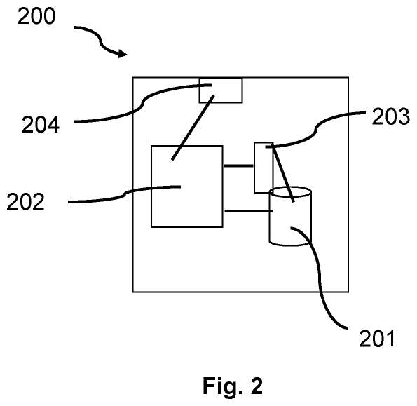

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions.

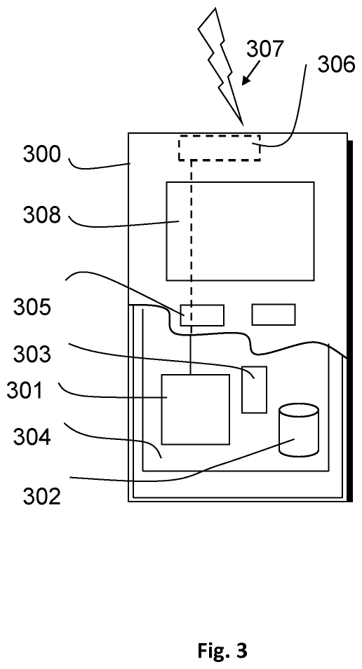

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may be configured to utilize human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or′ wireless) to other devices and/or for connecting external accessories, for example hands-free equipment, thereto.

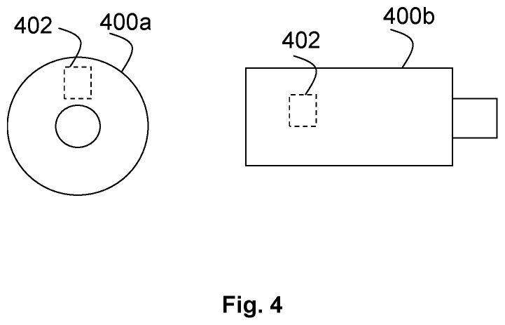

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 8 and/or FIG. 9 and/or FIG. 10, and/or FIG. 11, and/or FIG. 12, and/or methods otherwise described previously.

As provided herein, various aspects are described in the detailed description of examples and in the claims. In general, some examples may be implemented in hardware or special purpose circuits, software, logic or any combination thereof. For example, some aspects may be implemented in hardware, while other aspects may be implemented in firmware or software which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures, e.g., as in FIG. 8 and/or FIG. 9 and/or FIG. 10, and/or FIG. 11, and/or FIG. 12, and/or otherwise described previously, may represent program steps, or interconnected logic circuits, blocks and functions, or a combination of program steps and logic circuits, blocks and functions. The software may be stored on such physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory (ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not utilized for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

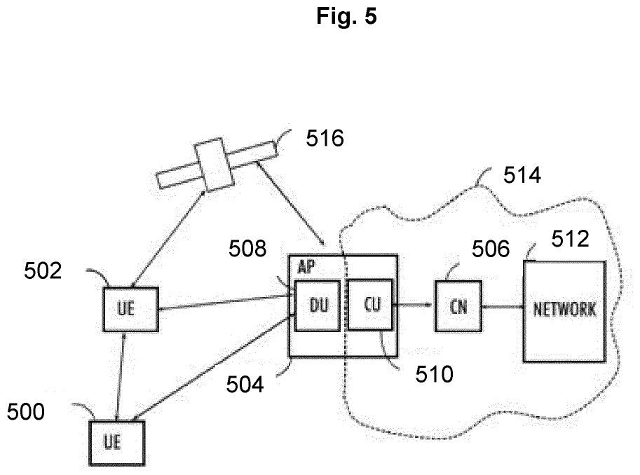

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g) NodeB serving devices in a cell. In one example, the node 504 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 506 (CN or next generation core NGC). Depending on the deployed technology, the (e/g) NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHZ-cmWave, 6 or above 24 GHZ-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The LTE network architecture is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). This may also be referred to as Edge computing when performed away from the core network. The communication system may also comprise a central control entity, or a like, providing facilities for networks of different operators to cooperate for example in spectrum sharing.

The technology of Edge computing may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where Edge computing servers can be placed between the core and the base station or nodeB (gNB). One example of Edge computing is MEC, which is defined by the European Telecommunications Standards Institute. It should be appreciated that MEC (and other Edge computing protocols) can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The depicted system is only an example of a part of a radio access system and in practice, the system may comprise a plurality of (e/g) NodeBs, the device may have an access to a plurality of radio cells and the system may comprise also other apparatuses, such as physical layer relay nodes or other network elements, etc. At least one of the (e/g) NodeBs may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 5 may provide any kind of these cells. A cellular radio system may be implemented as a multilayer network including several kinds of cells.

### ANNEX A

### Abstract of the Contribution: This Annex Proposes an Example Update to the Solution #33 for KI #8

### 1 Discussion

The FS_eLCS_Ph3 SID objectives reads
WT #6: Study enhancements to support the location service continuity for UE mobility, i.e. between EPS and 5GS;

Key Issue #8: support of location service continuity in case of UE mobility says the following:
For commercial location service, in particular the use case on vehicle (V2X) UE, it is very likely that UE moves between EPS and 5GS, and continuous UE positioning (periodical location service/LDR) is required. Following UE mobility scenarios are considered under this key issue:
UE mobility between EPS and 5GS (bi-direction).
UE mobility between NG-RAN node.

This example proposal provides an update to solution #33 for LCS continuity between EPS and 5GS in both directions.

### 2 Example Proposal

It is proposed to update TR 23.700-71-“Study enhancement to the 5GC LoCation Services (LCS); Phase 3” as follows

### ***Start of Changes***

### 6.0 Mapping Solutions to Key Issues

TABLE 6.0-1
Mapping Solutions to Key Issues

| | Key Issues | | | | | | | | | | | |
|---|---|---|---|---|---|---|---|---|---|---|---|---|
| Solutions | 1 | 2 | 3 | 4 | 5 | 6 | 7 | 8 | 9 | 10 | 11 | 12 |

| | |
|---|---|
| X | X |

### ***Next Change***

6.x Solution #8: Support of LCS Mobility when UE Moves Between 5GS and EPS

### 6.X.1 Introduction

This solution addresses the KI “Key Issue #8: support of location service continuity in case of UE mobility”.

Continuity of certain basic services like a PDU session during mobility is defined currently. However, the handling of an LCS session during mobility procedures is not specified. In particular, there is no specification on whether an ongoing LCS session shall be terminated or continued with after the mobility and if continued, how the continuity shall work. There can be many effects due to this missing part.
LCS sessions may be terminated at mobility with the LCS Client having to re-initiate the session after the procedure.
The LMF may not be aware of the mobility at all, leading to inaccurate positioning estimates.
Since there are no clear specifications, inter-vendor tests could fail.
LCS sessions could be enabled as part of other services (like emergency calls)—those services could be impacted due to the current specifications-leading to regulatory issues.

At least some of these issues could be mitigated or prevented if there is a clear specification on how LCS sessions are to be handled in different mobility procedures and in particular, if continuity can be guaranteed by the network.

Example considerations herein are:
Keep the changes minimal in EPC so that legacy functionality is incrementally change.
A standardized interface between the EPC-GMLC and 5GC-GMLC is not defined. As per section 4.2a. in TS 23.273, this interface, denoted as Lr′ is not standardized and in case EPC-GMLC and 5GC-GMLC are co-located, Lr′ is not needed altogether. This example doesn't require the standardization of this interface.
provide a common procedure for all types of Location Request (MO-LR/MT-LR with/without deferred location);
provide a simple example that works regardless of the current status of the on-going location procedure when the mobility event occurs;

### 6.X.2 Functional Description

This example proposal provides examples for mobility between 5GS and EPS with reference to FIGS. 13 and 14. FIGS. 12 and 13 illustrate example signalling.

### 6.X.3 Procedure

With reference to FIG. 13, the following is provided:

### Description

Steps 1-4 describe the normal MT-LR LCS session on 5GS (similar to steps 1.a. to 12 in FIG. 6.1.2-1 in TS 23.273.
Steps 5-14 describe the normal 5GS to EPS HO procedure (similar to steps 1 to 12.b in FIG. 4.11.1.2.1-1 in TS 23.502.
The AMF could initiate steps 15 and 17 in parallel to Step 11 when it receives the Relocation Response (Step 10).
Steps 15-16: The LCS Session on 5GS is cancelled.
Step 17: The AMF indicates failure to the 5GC-GMLC with reason “HO to EPC” and including the target MME ID.
Step 18: The 5GC-GMLC forwards the location request to the EPC-GMLC including all the parameters of the LCS Request and the target MME ID.
Steps 19-24: The LCS Session is started on EPS (similar to steps 1-10 in FIG. 9.18 in TS 23.271).
Steps 25-26: The UE location estimate is returned by the EPC-GMLC to the 5GC-GMLC which then forwards the same to the LCS Client.

### Note:

As can be observed, this example procedure is done in a way where the LCS Client is/may not aware of the mobility handling and the LCS session continuity is ensured.
There could be a mapping of LCS QoS (from the values defined for 5GS to values defined in 4GS)—this could be done by the GMLC.
   For QoS attributes that are common between 5GS and EPS, the original LCS QoS defined values can be used as is in EPS.
   For QoS attributes that are specific to 5GS->the QoS mapping could be done to the most stringent QoS value with best effort handling in QoS Class.
In case an LCS session was active over user plane in 5GS when the HO is triggered, then AMF (at step 10) may directly or through the LMF send to the UE the user plane assistance data of the EPS-UP Server before the HO is done. The UE could then use this assistance data to reach this server once a suitable PDN connection has been established or handed-over and then (re) establish a TLS session and SUPL session on EPS over which the LCS session can continue on the user plane in EPS.

With reference to FIG. 14, the following is provided:

### Description:

Steps 1-4 describe the normal MT-LR LCS session on EPS (similar to steps 1 to 3 in FIG. 6.1.2-1 in TS 23.271.
Steps 5-14 describe the normal EPS to 5GS HO procedure (similar to steps 1 to 16 in FIG. 4.11.1.2.2.2-1 and steps 1-4 in 4.11.1.2.2.3-1 in TS 23.502)
The MME could initiate steps 15 and 17 in parallel to Step 11 when it receives the Forward Relocation Response (Step 10)
Steps 15-16: The LCS Session on EPS is cancelled.
Step 17: The MME indicates failure to the EPC-GMLC with reason “HO to EPC” and including the target AMF ID.
Step 18: The EPC-GMLC forwards the location request to the 5GC-GMLC including all the parameters of the LCS Request and the target AMF ID.
Steps 19-24: The LCS Session is started on 5GS (similar to steps 1-23 in FIG. 6.1.2-1 in TS 23.273).
Steps 25-26: The UE location estimate is returned by the 5GC-GMLC to the EPC-GMLC which then forwards the same to the LCS Client.

### Note:

As can be observed, both of the example procedures can be defined in a way to keep the LCS Client unaware of the mobility signaling and the LCS session continuity is ensured.
There could be a mapping of LCS QoS (from the values defined for 5GS to values defined in 4GS or vice versa)—this could be done by the GMLC.
   For QoS attributes that are common between 5GS and EPS, the original LCS QoS defined values can be used as is in 5GS.
   For QoS attributes that are specific to EPS->the QoS mapping could be done to the most stringent QoS value with best effort handling in QoS Class.
In case the LMF is configured to use LCS over user plane in 5GS, then LMF chooses to initiate the LCS session over user plane at step 24.

### 6.X.4 Impacts on Services, Entities, and Interfaces

| | | | | LMF/eSMLC/ |
|---|---|---|---|---|
| | GMLC | AMF | MME | RAN/UE |
| 5GS −> | Transfer of LCS | Provide the target | | None |
| EPS | context from 5GS to | MME ID to GMLC as | | |
| Mobility | EPS | part of | | |
| | Mapping of LCS | Namf_Location_Response | | |
| | QoS from 5GS to | Trigger the sending | | |
| | EPS | of LCS UP server | | |
| | Initiating LCS | assistance data to | | |
| | session on EPS on | the UE as part of the | | |
| | target MME given by | HO procedure | | |
| | AMF | | | |
| EPS −> | Transfer of LCS | | Provide the target | None |
| 5GS | context from EPS to | | AMF ID to GMLC | |
| Mobility | 5GS | | as part of | |
| | Mapping of LCS | | Location_Response | |
| | QoS from EPS to | | | |
| | 5GS | | | |

### ***End of Changes***

1-35. (canceled)

36. A method for a user equipment, the method comprising:
receiving, when the user equipment is located in a first domain, from a first network function located in the first domain, assistance information identifying a user plane server providing location services for the user equipment over a user plane of another domain; and
establishing, after handover of the user equipment from the first domain to the another domain is performed, a data connection with the user plane server for providing location services for the user equipment over the user plane of the another domain, based on the assistance information.

37. An apparatus comprising: at least one processor; and at least one memory storing instructions that, when executed by the at least one processor, cause the apparatus at least to perform:
receiving, when the user equipment is located in a first domain, from a first network function located in the first domain, assistance information identifying a user plane server providing location services for the user equipment over a user plane of another domain; and
establishing, after handover of the user equipment from the first domain to the another domain is performed, a data connection with the user plane server for providing location services for the user equipment over the user plane of the another domain, based on the assistance information.

38. The apparatus of claim 37, wherein the data connection is a packet data network, PDN, connection; and wherein said assistance information is utilized to reach the user plane server over said PDN connection.

39. The apparatus of claim 37, wherein the assistance information is received prior to a command for said handover being sent towards the user equipment.

40. The apparatus of claim 37, wherein the first domain is configured as a third generation partnership project, 3GPP, 5G system, 5GS; and wherein the another domain is configured as a 3GPP evolved packet system, EPS.

41. The apparatus of claim 37, wherein the first network function is an access and mobility function.

42. The apparatus of claim 41, wherein the assistance information is received from the access and mobility function over non-access stratum, NAS, signalling.

43. The apparatus of claim 42, wherein the assistance information is received within a downlink-NAS-transport message from the access and mobility function.

44. An apparatus comprising: at least one processor; and at least one memory storing instructions that, when executed by the at least one processor, cause the apparatus at least to perform:
receiving assistance information from a first network function located in the first domain, based on a prior indication that a user plane-based location services session for the user equipment was active in another domain, wherein said assistance information identifies a user plane server for providing location services for the user equipment over a user plane of the first domain; and
establishing, after handover of the user equipment from the another domain to the first domain is performed, a data connection with the user plane server for providing location services for the user equipment over the user plane of the first domain, based on the assistance information.

45. The apparatus of claim 44, wherein the data connection is a packet data network, PDN, connection; and wherein said assistance information is utilized to reach the user plane server over said PDN connection.

46. The apparatus of claim 44, wherein the assistance information is received prior to a command for said handover being sent towards the user equipment.

47. The apparatus of claim 44, wherein the first domain is configured as a third generation partnership project, 3GPP, 5G system, 5GS; and wherein the another domain is configured as a 3GPP evolved packet system, EPS.

48. The apparatus of claim 44, wherein the first network function is an access and mobility function.

49. The apparatus of claim 48, wherein the assistance information is received from the access and mobility function over non-access stratum, NAS, signalling.

50. The apparatus of claim 49, wherein the assistance information is received within a downlink-NAS-transport message from the access and mobility function.
